(19) United States
(12) Patent Application Publication
(10) Pub. No.: US 2014/0267427 A1
(43) Pub. Date: Sep. 18, 2014

(54) PROJECTOR, METHOD OF CONTROLLING PROJECTOR, AND PROGRAM THEREOF

(71) Applicant: Fumihiro HASEGAWA, Tokyo (JP)

(72) Inventor: Fumihiro HASEGAWA, Tokyo (JP)

(21) Appl. No.: 14/206,075

(22) Filed: Mar. 12, 2014

(30) Foreign Application Priority Data
Mar. 13, 2013 (JP) 2013-050894

(51) Int. Cl. G06T 5/00

(52) U.S. Cl. CPC G06T 5/006
USPC 345/647

(57) ABSTRACT

A projector captures an image of a projection target, on which a projection image is projected, and corrects the projection image by using the captured image. The projector includes a projection unit that projects the projection image onto the projection target; a capture unit that captures an image of a projected region including the projection target; a calculation unit that calculates three-dimensional data regarding the projected region, and calculates a correction parameter, including a distortion parameter and a motion parameter, using the calculated three-dimensional data; and a correction unit that corrects the projection image using the correction parameter. The correction unit performs a first correction corresponding to a shape of the projection target using the distortion parameter, and performs a second correction corresponding to at least one of a movement of the projection unit and a movement of the projection target.

### BACKGROUND OF THE INVENTION

1. Field of the Invention

The disclosures herein generally relate to a projector and a method of controlling the projector.

2. Description of the Related Art

A projector projects an image (projection image) onto a projection target, such as a screen. Some projectors measure a distance to the projection target, and adjust focus for a projected image. Furthermore, some projectors capture an image of the projected image and adjust focus for the projected image based on the captured image.

Japanese Published Patent Application No. 2011-170174 discloses a projection stabilization apparatus which corrects a misalignment of a projected image on a screen (projection target) even when the position of an optical projection apparatus (projector) changes, by being jiggled, for example.

However, the projection stabilization apparatus disclosed in Japanese Published Patent Application No. 2011-170174 corrects the whole captured image, and cannot correct an influence from jiggling when the captured image is locally distorted according to an outer shape of the projection target. Furthermore, the projection stabilization apparatus disclosed in the Japanese Published Patent Application No. 2011-170174 cannot correct the captured image, simultaneously, when a relative positional relationship between the projection target and the projector changes and when the captured image is distorted according to the shape of the projection target.

### SUMMARY OF THE INVENTION

It is a general object of at least one embodiment of the present invention to provide a projector and a method of controlling the projector that substantially obviates one or more problems caused by the limitations and disadvantages of the related art.

In one embodiment, a projector captures an image of a projection target, a projection image being projected on the projection target, and corrects the projection image by using the captured image. The projector includes a projection unit that projects the projection image onto the projection target; a capture unit that captures an image of a projected region including the projection target; a calculation unit that calculates three-dimensional data regarding the projected region, and calculates a correction parameter using the calculated three-dimensional data; and a correction unit that corrects the projection image using the correction parameter calculated by the calculation unit. The calculation unit calculates a distortion parameter and a motion parameter, as the correction parameter, based on the captured image. The correction unit performs a first correction corresponding to a shape of the projection target using the distortion parameter, and performs a second correction corresponding to at least one of a movement of the projection unit and a movement of the projection target.

In another embodiment of the present invention, a method of controlling a projector, which captures an image of a projection target, a projection image being projected on the projection target, and corrects the projection image by using the captured image, includes projecting the projection image onto the projection target; capturing an image of a projected region including the projection target, by using a capture unit; calculating three-dimensional data regarding the projected region, and calculating a correction parameter using the calculated three-dimensional data; and correcting the projection image using the calculated correction parameter. The correction parameter includes a distortion parameter and a motion parameter. The distortion parameter is used in performing a first correction corresponding to a shape of the projection target, and the motion parameter is used in performing a second correction corresponding to at least one of a movement of the projection unit and a movement of the projection target. The corrected projection image is projected.

In yet another embodiment of the present invention, a non-transitory computer-readable storage medium storing a program for causing a projector to perform a process of capturing an image of a projection target, a projection image being projected on the projection target, and correcting the projection image by using the captured image, the process includes a step of projecting the projection image onto the projection target; a step of capturing an image of a projected region including the projection target, by using a capture unit; a step of calculating three-dimensional data regarding the projected region, and calculating a correction parameter using the calculated three-dimensional data; and a step of correcting the projection image using the calculated correction parameter. The correction parameter includes a distortion parameter and a motion parameter. The distortion parameter is used in performing a first correction corresponding to a shape of the projection target, and the motion parameter is used in performing a second correction corresponding to at least one of a movement of the projection unit and a movement of the projection target. The corrected projection image is projected.

According to the present invention, a projector and a method of controlling the projector, which can perform a correction when a relative positional relationship between a projection target and the projector changes and a correction corresponding to a shape of the projection target are provided.

### BRIEF DESCRIPTION OF THE DRAWINGS

Other objects and further features of embodiments will be apparent from the following detailed description when read in conjunction with the accompanying drawings, in which:

FIGS. 1A and 1B are schematic external views illustrating an example of a projector according to a present embodiment;

FIG. 2 is an explanatory diagram illustrating an example of an operation of the projector according to the present embodiment;

FIGS. 3A and 3B are explanatory diagrams illustrating an example of a correction operation for a projection image by the projector according to the present embodiment;

FIG. 4 is an explanatory diagram illustrating an example of an operation for projecting a projection image, which is rectified by the projector according to the present embodiment;

FIG. 5 is an explanatory diagram illustrating an example of a configuration of a projector according to a first embodiment;

FIG. 6 is a functional block diagram illustrating an example of functions of the projector according to the first embodiment;

FIGS. 7A to 7D are explanatory diagrams illustrating an example of a distortion of the projected image projected by the projector according to the present embodiment;

FIG. 8 is an explanatory diagram illustrating an example of a correction parameter (motion parameter) calculated by a calculation unit of the projector according to the first embodiment;

FIG. 9 is a flowchart illustrating an example of a projection operation of the projector according to the first embodiment;

FIG. 10 is a flowchart illustrating an example of a correction operation of the projector according to the first embodiment;

FIG. 11 is an explanatory diagram illustrating an example of an operation for extracting a feature point by the projector according to the first embodiment;

FIG. 12 is an explanatory diagram illustrating an example of an operation for projecting a pattern by the projector according to the first embodiment;

FIG. 13 is an explanatory diagram illustrating an example of a captured image when the pattern is projected by the projector according to the first embodiment;

FIG. 14 is a flowchart illustrating an example of a projection operation and a correction operation of a projector according to a second embodiment;

FIGS. 15A and 15B are schematic external views illustrating an example of a projector according to a first example;

FIG. 16 is an explanatory diagram illustrating an example of an operation of jiggling a projector according to a second example;

FIGS. 17A to 17D are explanatory diagrams illustrating an operation of projection onto a projection target of a projector according to a third example;

FIG. 18 is an explanatory diagram illustrating an example of an operation of a projector according to a fourth example; and

FIG. 19 is a flowchart illustrating an example of a projection operation of the projector according to the fourth example.

### DESCRIPTION OF THE PREFERRED EMBODIMENTS

In the following, embodiments of the present invention will be described with reference to the accompanying drawings.

An unlimited exemplary embodiment of the present invention will be explained using a projector, which captures an image of a projection target, on which a projection image is projected, and corrects the projection image based on the captured image. The present invention can be applied not only to the projector, which will be explained in the following, but also to any other device, apparatus, a unit system or the like, which projects a projection image and captures an image of the projected image, such as a projection and capture device, a projection device, a capture device, or the like.

The image in the present embodiment includes a still image, a video, or the like. Projection of an image in the present embodiment includes projection, screening, irradiation, or the like. Capture of an image in the present embodiment includes photographing an image, saving an image, or the like. Moreover, the projection target includes a screen, a wall, a white board, an outer surface, such as an outer wall of a building, a surface of a moving object on which an image can be projected, or the like.

In the following, the same or corresponding numerical symbols are assigned to the same or corresponding members in the accompanying drawings, and duplicate explanation is omitted. Moreover, the accompanying drawings do not aim at indicating a relative ratio between elements or parts. Accordingly, a specific size may be determined by a person skilled in the art in light of the descriptions in the unlimited embodiments in the following.

The present invention will be explained in the order of the following list, using the projector according to the present embodiment of the present invention.

1. Projector, projection operation, and capture operation;
2. A first embodiment;
3. A second embodiment;
4. A program and a recording medium; and
5. Examples (first example to fourth example)

### Projector, Projection Operation and Capture Operation

A projector 100 according to the present invention will be explained with reference to FIGS. 1A to 4.

FIGS. 1A and 1B are a schematic front external view and a schematic rear external view of an example of the projector 100 according to the present invention, respectively. FIG. 2 is an explanatory diagram illustrating an example of a projection operation of the projector 100. FIG. 3A is an explanatory diagram illustrating an example of an operation for calculating a correction parameter by the projector 100 (calculation unit 14, which will be explained later). FIG. 3B is an explanatory diagram illustrating an example of an operation for correcting the projection image by the projector 100 (correction unit 15, which will be explained later). FIG. 4 is an explanatory diagram illustrating an example of an operation for projecting the projection image (rectified image), which is rectified by the projector 100.

As shown in FIG. 1A, the projector 100 includes, on the front surface, a projection unit 100P, which projects a projection image, and a capture unit 100C, which captures an image of a region where the projection image is projected. Moreover, as shown in FIG. 1B, the projector 100 includes, on the rear surface, includes a start button 100Ba, which receives an input for an implementation timing of an operation desired by a user, a settings button 100Bb, which sets the operation desired by the user, and a selection button 100Bc, which receives a selection for selecting information desired by the user.

The schematic external view of the projector, to which the present invention can be applied, is not limited to FIGS. 1A and 1B. For example, the external view of the projector may be an external view of the projector 110 (First Example), as shown in FIG. 15, which will be explained later, or an external view having other projection unit and capture unit.

As shown in FIG. 2, the projector 100 projects an image onto a screen or the like, which will be denoted as a “projection target” in the following. The projector 100 starts projecting the image, when the user depresses the start button 100Ba, for example. In FIG. 2, the projector 100 projects the image in a projection region Rgn-P, by using the projection unit 100P (see FIG. 1A).

Moreover, in FIG. 2, the projector 100 captures an image of a capture region Rgn-C (projected region) by using the capture unit 100C (see FIG. 1A). The projector 100 starts capturing an image, when the user depresses the start button 100Ba (see FIG. 1B).

Furthermore, in FIG. 2, the projector 100 can select a projection target region Rgn-T, as a region in which the projection image is projected. The projector 100 selects a size and a position of the projection target region Rgn-T according to the user's operation for the selection button 100Bc (see FIG. 1B), and sets the projection target region Rgn-T according to the user's operation for the setting button Bb (See FIG. 1B).

As shown in FIG. 3A, when the capture region Rgn-C (see FIG. 2) is captured by using the capture unit 100C (see FIG. 1), the projector 100 captures the capture region Rgn-C as shown in FIG. 2, for example. That is, the capture unit 100C captures a captured image Img-C, which is deformed corresponding to a shape (for example an outer shape) of the projection target. The projector 100 (calculating unit 14, which will be explained later) calculates a correction parameter (projective transformation matrix H, which will be explained later), so that the captured image Img-C becomes a captured reference image Img-Cr.

As shown in FIG. 3B, the projector 100 (correction unit 15, which will be explained later) corrects the projection image Img-P by using the calculated correction parameter (projective transformation matrix H), and newly generates a rectified image Img-R. When the user depresses the start button 100Ba (see FIG. 1A), for example, the projector 100 calculates the correction parameter (projective transformation matrix H, which will be explained later). When the user further depresses the start button 100Ba, the rectified image Img-R may be projected.

As shown in FIG. 4, the projector 100 uses the rectified image Img-R, which has been newly generated, as the projection image Img-P. That is, the projector 100 projects the rectified image Img-R, and a projected image, which compensates for a deformation corresponding to the shape of the projection target, appears on the screen.

In the following, configuration, function and operation of the projector according to the embodiment of the present invention will be specifically explained.

### First Embodiment

### Configuration of Projector

A configuration of the projector 100 according to the first embodiment of the present invention will be explained with reference to FIG. 5. FIG. 5 is a schematic configuration diagram illustrating an example of a configuration of the projector 100 according to the first embodiment.

As shown in FIG. 5, the projector 100 according to the present embodiment includes a control unit 10, which controls an operation of the projector 100, an image generation unit 11, which generates a projection image Img-P, and a projection unit 12, which projects the generated projection image Img-P. Moreover, the projector 100 includes a capture unit 13, which captures an image of the capture region Rgn-C (see FIG. 2), a calculation unit 14, which calculates the correction parameter, and a correction unit 15, which corrects the projection image Img-P. Furthermore, the projector 100 may include an input/output unit 16, which inputs/outputs information to/from outside the projector 100, and a storage unit 17, which stores information regarding the operation of the projector 100.

The projector 100, using the image generation unit 11, based on the information input by the input/output unit 16, generates the projection image Img-P. Moreover, the projector 100, in the present embodiment, using the projection unit 12, projects the generated projection image Img-P onto the projection target. Furthermore, the projector 100, using the capture unit 13, captures an image of the capture region Rgn-C (see FIG. 2) including the projection target, on which the projection image Img-P is projected.

The projector 100 according to the present embodiment, calculates the correction parameter (distortion parameter and motion parameter, which will be explained later) using the calculation unit 14, based on the captured image Img-C, captured by the capture unit 13. Moreover, the projector 100 according to the present embodiment, using the correction unit 15, based on the correction parameter calculated by the calculation unit 14, generates rectified image Img-R. Furthermore, the projector 10 according to the present embodiment, using the projection unit 12, projects the rectified image Img-R, as the projection image Img-P. Accordingly, the projector 100 according to the present embodiment, the correction operation when the relative positional relationship between the projection target and the projector changes and the correction corresponding to the shape of the projection target can be simultaneously implemented.

The control unit 10 sends instruction to each of the elements of the projector 100, and controls the operation of each of the elements. The control unit 10, for example, controls the operation of the image generation unit 11, or the like. Moreover, the control unit 10 can control the operation of the projector 100, using a program (control program and an application program or the like), which is previously stored, for example, in the storage unit 17. Furthermore, the control unit 10, based on the information input from the input/output unit 16 (an operation unit 16P), may control the operation of the projector 100. Moreover, the control unit 10, using the input/output unit 16 (operation unit 16P), may output information regarding the projector 100, such as the operation information, processing information, correction information, captured image, of the like.

The image generation unit 11 generates an image to be projected. The image generation unit 11, based on the information input from the input/output unit 16 (projection image acquisition unit 16M) or the like, generates a projection image Img-P. Moreover, in the case of projecting a pattern when the image is rectified or the operation is calibrated, the image generation unit 11 may generate a pattern image based on information input from the input unit 16 or the like.

The projection unit 12 projects an image. The projection unit projects the generated projection image Img-P onto the projection target. In the case of projecting a pattern when the image is rectified or the operation is calibrated, the projection unit 12 may project the pattern image generated by the image generation unit 11. The projection unit 12 includes a light source, a lens, a projected light process unit, and a projected image storage unit.

The capture unit 13 captures (acquires) a captured image (captured data). The capture unit 13 forms an image of the image in the capture region Rgn-C (see FIG. 2) at an image element (an image sensor), and acquires a pixel output signal from the image element as the captured data (captured image Img-C). The capture unit 13, in the present embodiment, captures plural captured images Img-C, timings of capture for which are different from each other. Moreover, in the capture unit 13, a stereo camera is used.

The stereo camera includes two capture lenses and two capture elements, and captures images of the projection target with the two capture lenses, simultaneously. The capture lens injects an image of the projection target into the image element. The image element includes a light reception surface, on which plural light receiving elements are arranged in a lattice-like pattern. Light from the region including the projection target injected through the capture lens forms an image on the light receiving surface. A solid capture element, an organic capture element, or the like is used for the capture element.

The calculation unit 14 calculates the correction parameter. The calculation unit 14 calculates three-dimensional data regarding the projection region Rgn-P by using the plural images captured by the capture unit 13. Moreover, calculation unit 14 calculates the correction parameter by using the calculated three-dimensional data.

Specifically, the calculation unit 14, using the two captured images Img-C simultaneously captured by the stereo camera (capture unit 13), calculates a distance from the projector 100 to the projection target and a shape of the projection target, which will be denoted as “three-dimensional data” in the following, based on the principle of triangulation.

Moreover, the calculation unit 14, using the calculated three-dimensional data, as the correction parameter, calculates the distortion parameter and the motion parameter. The calculation unit 14 uses one captured image out of the plural captured images, and calculates the distortion parameter. Moreover, the calculation unit 14 calculates the motion parameter using two captured images out of the plural captured images. That is, in the case that the relative positional relationship between the projection target and the capture unit 13 changes, the calculation unit 14 uses one captured image before the relative positional relationship changes and one captured image after the relative positional relationship changes to calculate the motion parameter. Moreover, the calculation unit 14 updates the distortion parameter using the calculated motion parameter.

The distortion parameter is a parameter used for correcting a distortion in the projected image, corresponding to the shape of the projection target. The correction includes an imaging process, such as enlargement, contraction, trapezoidal correction, and is denoted as “distortion correction” in the following. The projector 100 uses the distortion parameter and corrects the distortion of the projected image viewed by the user, in the case that the projection target, such as a screen, is distorted, the projection target does not directly face the capture unit 13, i.e. the projector 100 or the like.

The motion parameter is a parameter used for correcting an unnecessary motion such as jiggling, corresponding to a movement of the projection unit 12 and/or the projection target. The correction includes image processing, such as translation, rotation or the like, and is denoted as “motion correction” in the following. When the projection target and/or the capture unit 13 (projector 13) moves, the projector 100, using the motion parameter, corrects the movement of the projected image viewed by the user. For example, when the capture unit 13 (projector 13) is jiggled, the projector 100, using the motion parameter, halts the movement of the projected image viewed by the user, for example.

The correction parameters (distortion parameter and the motion parameter) will be explained later in the section “function of projector”.

The correction unit 15 corrects the projection image. The correction unit 15 corrects the projection image Img-P by using the correction parameters.

Specifically, the correction unit 15 corrects the distortion in the projected image due to the shape of the projection target using the distortion parameter calculated by the calculation unit 14. Moreover, the correction unit 15, using the motion parameter calculated by the calculation unit 14, corrects the motion of the projected image due to the movement of the projection unit 12 and/or the projection target. The operation of correction of the correction unit 15 using the correction parameters (distortion parameter and the motion parameter) will be explained later in the section “operation for projecting image”.

The input/output unit 16 inputs/outputs information (for example, an electric signal) to/from the outside of the projector 100. The input/output unit 16 according to the present embodiment includes the operation unit 16P and projection image acquisition unit 16M. The operation unit 16P is an operational panel, which the user operates (user interface). The operation unit 16P receives a condition for the projection or the capture, input by the user using the projector 100, outputs information on the operational condition and the operational state to the user. The projection image acquisition unit 16M receives an input of data regarding an image projected from an external PC or the like (computer interface).

The storage unit 17 stores information regarding the operation of the projector 100. The storage unit 17 stores information regarding processing statuses during operation and during waiting (projection image, captured image, or the like). The related art can be applied to the storage unit 17.

[Function of Projector]

With reference to FIG. 6, the function of the projector according to the first embodiment will be described. FIG. 6 is a functional block diagram illustrating an example of functions of the projector 100 according to the first embodiment.

As shown in FIG. 6, the projector 100 according to the present embodiment, at block B01, by an instruction for operation input from the input/output unit 16 (operation unit 16P or the like) by the user, acquires “information on projection of image (information on projection image, information on start of projection, or the like)”. Then, the input/output unit 16 (projector 100) outputs the acquired “information on projection of image” to the control unit 10.

The control unit 10, at block B02, based on the input “information on projection of image”, outputs an “image generation instruction” to the image generation unit 11. Moreover, the control unit 10, based on the input “information on projection of image”, outputs a “projection instruction” to the projection unit 12. Furthermore, the control unit 10, based on the input “information on projection of image”, outputs a “capture instruction” to the capture unit 13.

The control unit 10 according to the present embodiment, based on “calculated data (for example, the three-dimensional data)” calculated by the calculation unit 14, which will be explained later, determines whether the distortion correction and/or the motion correction are performed or not. When the control unit 10 determines that the distortion correction and/or the motion correction are performed, the control unit 10 outputs a “correction instruction (not shown)” to an image generation unit 11, which will be explained later, and the correction unit 15.

The image generation unit 11, at block B03, based on the input “image generation instruction”, using the “information on projection of image (information on projection image)” acquired by the input/output unit 16, generates image data (projection image Img-P). Moreover, the image generation unit 11 outputs the generated “image data (projection image Img-P) to the projection unit 12.

The image generation unit 11 according to the present embodiment, when the “correction instruction (not shown)” is input from the control unit 10 (block B02), outputs “image data (projection image Img-P)” generated in the generation unit 15 (at block B07)” to the projection unit 12. Moreover, the image generation unit 11, instead of the generated “image data (projection image Img-P)”, outputs “correction data (rectified image Img-R)” input from the correction unit 15 to the projection unit 12.

The projection unit 12, at block B04, based on the input “projection instruction”, projects the “image data (projection image Img-P)” input from the image generation unit 11.

The projection unit 12 according to the present embodiment, when the control unit 10 (at block B02) inputs “correction instruction (not shown)” to the image generation unit 11 and the like, projects the “correction data (rectified image Img-R)” input from the image generation unit 11.

The capture unit 13, at block B05, based on the input “capture instruction”, acquires (captures) the “captured data (captured image Img-C)” in the projection region Rgn-P (see FIG. 2). Moreover, the capture unit 13 outputs the acquired (captured) “captured data (captured image Img-C)” to the calculation unit 14. The capture unit 13 captures images of the region including the projection target by using the stereo camera, and acquires two captured data.

The calculation unit 14, at block B06, based on the two “captured data” input from the capture unit 13, calculates “calculated data (three-dimensional data)” corresponding to plural positions on the outer surface of the projection target. The plural positions are denoted as “feature points” in the following. Moreover, the calculation unit 14 outputs the “calculated data (three-dimensional data)” to the control unit 10. The “calculated data (three-dimensional data)” are data regarding the distance between the projector 100 (capture unit 13) and the projection target (corresponding point)”.

The calculation unit 14 according to the present embodiment, when the control unit 10 (block B02) inputs the “correction instruction (not shown)”, calculates the correction parameters (distortion parameter and the motion parameter)”. Moreover, the calculation unit 14 outputs the calculated correction parameter to the correction unit 15 (block B07), which will be explained later.

FIGS. 7A to 7D are explanatory diagrams illustrating an example of the distortion in the projected image projected by the projector 100. FIG. 7A illustrates an example of projection where a projector with a short focal length (or a very short focal length) projects a projection image onto a screen Scr (projection target). FIG. 7B illustrates an example of a captured image of the projected image on the projection target Scr projected by the projector with a short focal length (or a very short focal length), which is captured by the capture unit facing the projection target Scr. FIG. 7C illustrates an example of projection where a projector with a normal focal length projects a projection image onto the projection target Scr. FIG. 7D illustrates an example of a captured image of the projected image on the projection target Scr projected by the projector with a normal focal length, which is captured by the capture unit facing the projection target Scr.

As shown in FIG. 7A, when the projector with a short focal length irradiates (projects) projection light L1, L2 and L3 onto a projection surface of the projection target Scr, the projection light L1, L2 and L3 are reflected off the surface of the projection target into reflection light L1r, L2r and L3r, respectively. Since the projection target is distorted where the projection light L2 enters, the projection light L2 is reflected at a different point off the surface of the projection target, from a point when the projection target is not distorted (reflection light is L2ra). In the case of the projector with a short focal length, the deviation of the reflection light L2r from L2ra becomes large. Accordingly, as shown in FIG. 7B, in the case of the projector with a short focal length, from the position facing the projection target Scr, a local part in the captured image Img-C viewed by a user is distorted from L2ra to L2r. In the case of the projector with a short focal length, the incidence angle of the projection light becomes small, and the deviation of the reflection point (distortion in the image) becomes large, even if the distortion of the projection surface is small.

The projector 100 according to the present embodiment, using the calculation unit 14, calculates a distortion parameter, which compensates for the distortion of the local part in the captured image Img-C, as the correction parameter. That is, the calculation unit 14 calculates the distortion parameter, which deforms the local part in the captured image Img-C, as shown in FIG. 7B, so that the reflected light L2r for the distorted surface coincides with the reflected light L2ra for the undistorted surface.

On the other hand, as shown in FIG. 7C, projection light La, Lb and Lc (projection image), irradiated (projected) from the projector with a normal focal length onto the projection surface of the projection target Scr, are reflected off the surface of the projection target into reflection light Lar, Lbr and Lcr, respectively. In the case of the projector with a normal focal length, the deviation of the reflection light Lbr from the reflection light reflected by an undistorted surface (not shown) is small. That is, the projector with a normal focal length is negligible to the shape (distortion) in the projection surface of the projection target, as shown in FIG. 7D.

At first, the calculation unit 14 (projector 100), in order to calculate the distortion parameter, obtains a three-dimensional shape of the capture region Rgn-C including the projection target. The calculation unit 14 calculates three-dimensional coordinates for each point in the capture region Rgn-C, wherein the center position of the capture region Rgn-C is the origin of the three-dimensional coordinate system. The three-dimensional coordinate in the above coordinate system will be denoted as “projector coordinate” in the following. The calculation unit 14 according to the present embodiment divides the capture region Rgn-C into plural small regions (for example, pixels, meshes, or the like), and calculates three-dimensional coordinates (and correction parameter) for each of the small regions.

Moreover, the calculation unit 14 may further calculate the three-dimensional coordinates by using an internal parameter for the projector 10 (an aspect ratio, a focal length, a keystone correction, or the like) and an external parameter for the projection target (posture, a position, or the like), which are previously stored in the storage unit 17, which will be explained later. In the case that the shape on the surface of the projection target where the projected light is irradiated is a circle, the origin of the three dimensional coordinate system may be set to the center of the circle.

The calculation unit 14 according to the present embodiment, as the distortion parameter (correction parameter), calculates a projective transformation matrix H with respect to the normal direction to the capture region Rgn-C (or the direction to the user, who views the projection target. The projective transformation matrix H is defined by eight coefficients, h₁ to h₈, as follows:

$$H = ( \begin{matrix}{h}_{1} & {h}_{2} & {h}_{3} \\ {h}_{4} & {h}_{5} & {h}_{6} \\ {h}_{7} & {h}_{8} & 1\end{matrix} ) \qquad Formula 1$$

The center position (xₚ₀, yₚ₀) of the small region in the capture region Rgn-C, divided as above, is transformed by the projector 100 onto a position (xₚ₁, yₚ₁) by using the projective transformation matrix H as follows:

xₚ₁=(h₁*xₚ₀+h₂*yₚ₀+h₃)/(h₇*xₚ₀+h₈*yₚ₀+1) Formula 2

yₚ₁=(h₄*xₚ₀+h₅*yₚ₀+h₃)/(h₇*xₚ₀+h₈*yₚ₀+1) Formula 3

The eight parameters in the matrix H can be obtained from the above relations.

The calculation unit 14 calculates the projective transformation matrix H (coefficients h₁ to h₈) for each of the divided small regions. The calculation unit 14 stores the calculated projective transformation matrix H (distortion parameter) for all the divided small regions, as the correction parameters, into the storage unit 17 (see FIG. 5).

Next, the calculation unit 14 (projector 100), in order to calculate the motion parameter, extracts feature points included in the image of the “captured data (captured image Img-C)”, input by the capture unit 13. An example of the operation for extracting feature points will be explained later in the section “example of operation for extracting feature points”.

The calculation unit 14 according to the present embodiment, when the relative positional relationship between the projection target and the capture unit 13 (projector 100) changes, calculates the motion parameter by using the “captured data (captured image)” before and after the change. The calculation unit 14 calculates the motion parameter by using the “one captured data (one captured image Img-C, for example, the reference picture)” before the relative positional relationship changes, and the “other captured data (other captured image Img-C, for example, the image for detection)” after the relative positional relationship changes. That is, the calculation unit 14 performs a matching process for the extracted feature points, and calculates the matrix Pₘ, representing a motion of the small region (pixel, mesh or the like) corresponding to the change in the relative positional relationship. Moreover, the calculation unit 14 calculates one matrix Pₘ for the “captured data (whole captured image Img-C)” before and after the change in the relative positional relationship.

The matrix Pₘ can be expressed by a rotational matrix R (3 by 3 matrix) and a translational vector (3 dimensional). The degrees of freedom for the matrix Pₘ is six, since the degrees of freedom of the rotation is three and the degrees of freedom of the translation is three. The calculation unit 14 can uniquely determine the matrix Pₘ by three corresponding points (by performing the matching for three feature points). The calculation unit 14 may calculate Pₘ from more than three corresponding points by performing the matching for feature points, by using the least square method. The calculation accuracy becomes higher by using a large number of feature points.

FIG. 8 is an explanatory diagram illustrating an example of the correction parameter (motion parameter). In FIG. 8, a movement of the projector 100A and the camera 100B while the projector 100A projects an image onto the screen Scr (projection target) and the camera 100B (and the virtual camera 100C) captures the projected image.

As shown in FIG. 8, in each of the projectors 100A and 100B, the projection unit 12 and the capture unit 13 are integrated with each other, and when the position of the projector 100A or the camera 100B changes, the projector 100A and the camera 100B are displaced by the perspective projection matrix Pₚ and P_{c}. Accordingly, the relation between mₚ and M and the relation between m_{c} and M are expressed by the product with the perspective projection matrices Pₚ and P_{c}, respectively. Moreover, for the virtual camera 100C, the relation between m_{c}′ and M is similarly expressed by the product with the perspective projection matrix P_{c}′.

That is, the matrix Pₘ (motion parameter) is calculated so that mₚᵣ, after the relative positional relationship changes, satisfies the relation between mₚ and M. Or, the matrix Pₘ (motion parameter) is calculated so that m_{cr}, after the relative positional relationship changes, satisfies the relation between m_{c} and M.

The process returns to FIG. 6. The correction unit 15, at block B07, based on the “correction instruction (not shown)” input by the control unit 10 (at block B02), corrects the “image data” input by the image generation unit (at block B03). The correction unit 15 performs image processing (correction) for the projection image Img-P by using the “calculation data (correction parameter)” input by the calculation unit 14 (at block B06). Moreover, the correction unit 15 outputs the rectified “corrected data (rectified image Img-R)” to the image generation unit 11.

The correction unit 15 according to the present embodiment performs image processing (correction) for the projection image Img-P by using the distortion parameter (projective transformation matrix H) calculated by the calculation unit 14, in the case that the “correction instruction” from the control unit 10 relates to the distortion correction. Moreover, in the case that the “correction instruction” relates to the motion correction, the correction unit 15 updates the distortion parameter (projective transformation matrix H) using the motion parameter (matrix Pₘ) calculated by the calculation unit 14, and performs image processing (correction) for the projection image Img-P using the updated distortion parameter.

[Operation for Projecting Image]

With reference to FIGS. 9 and 10, the operation for projecting an image (projection image, rectified image, or the like) by the projector 100 according to the first embodiment will be described. FIG. 9 is a flowchart illustrating an example of the operation (projection operation) of the projector according to the present embodiment. FIG. 10 is a flowchart illustrating an example of the operation (calculation and update for the distortion parameter) by the projector 100.

At first, when the projector 100 according to the present embodiment projects an image, the projector 100 performs the processes at steps S901 to S913 in FIG. 9. The projector 100 has previously performed the processes at steps S1001 to S1005 in FIG. 10, and calculated the distortion parameter (correction parameter). The operations illustrated in FIGS. 9 and 10 will be explained in the following.

As shown in FIG. 9, the projector 100 according to the present embodiment, at step S901, projects the projection image Img-P onto the projection region Rgn-P (see FIG. 2) including the projection target, using the projection unit 100P (see FIG. 1) (projection step). During the above operation, the user depresses the start button (calibration button) 100Ba (see FIG. 1B) on the projector 100, the capture unit 100C (see FIG. 1) acquires the captured image Img-C (capture step). Moreover, the user depresses the selection button 100Bc (see FIG. 1B) and depresses the setting button 100Bb (see FIG. 1B) on the projector 100, and the projection target region Rgn-T (see FIG. 2) is selected. The coordinates of the projection target region Rgn-T are calculated in the projector.

The process of the projector 100 proceeds to step S902.

The projector 100, at step S902, using the control unit (see FIG. 5), determines whether it is the timing for reloading the correction parameter. The control unit 10 may determine the timing for reloading the correction parameter when the predetermined time has elapsed, for example. Moreover, the control unit 10 may determine the timing for reloading the correction parameter when the user depresses the start button (calibration button) 100Ba.

The predetermined time may depend on the specification of the projector 100 or the status of use. Moreover, the predetermined time may be determined experimentally, or determined by previous calculation.

The process of the projector 100 proceeds to step S903, when it is determined to be the timing for reloading the correction parameter (step S902 YES). Otherwise, the process proceeds to step S904.

The projector 100, at step S903, using the control unit 10, reloads the correction parameter. The control unit 10 reads out the correction parameter, which is stored in the storage unit 17 (see FIG. 5). Then, the process of the projector 100 proceeds to step S904.

Moreover, the projector 100 according to the present embodiment, at step S903, may update (calculate) the correction parameter (distortion parameter), shown in FIG. 10 (calculation step).

Specifically, at step S1001, the user depresses the selection button 100Bc and the setting button 100Bb on the projector 100, and the projection target region Rgn-T is selected. Next, the projector 100, at step S1002, using the projection unit 100P, irradiates the pattern light for calibration. The projector 100 captures an image of the region including the pattern light for calibration, using the capture unit 100C.

Next, the projector 100, at step S1004, using the calculation unit 14, based on the image captured for the region including the pattern light for calibration, calculates the distortion parameter (calculation step). Moreover, the projector 100, at step S1005, using the storage unit 17, updates the distortion parameter by overwriting it with the calculated distortion parameter.

The process of the projector 100 returns to step S903 in FIG. 9.

Next, at step S904 in FIG. 9, the projector 100, using the correction unit 15 (see FIG. 5), corrects the projection image Img-P (correction step). The correction unit 15, using the distortion parameter (correction parameter), performs image processing (correction) for the projection image Img-P, and generates a rectified image Img-R. Moreover, the correction unit 15 outputs the generated rectified image Img-R to the projection unit 12.

The process of the projector 100 proceeds to step S905.

Next, at step S905, the projector 100, using the projection unit 12 (see FIG. 5), projects the projection image Img-P (projection step). The projection unit 12, projects the rectified image Img-R, which was rectified at step S904, as the projection image Img-P.

After starting the projection, the process of the projector 100 proceeds to step S906.

The projector 100, at step S906, using the control unit 10, determines whether it is the timing for capturing an image or not. The control unit 10 determines the timing for capturing an image when the relative positional relationship between the projection target and the capture unit changes. Moreover, the control unit may determine the timing for capturing the image when the user depresses the start button (calibration button) 100Ba.

When the projector 100 determines the timing for capturing the image (step S906 YES), the process of the projector 100 proceeds to step S907. Otherwise, the process proceeds to step S913.

In the processes from steps S907 to S912, the projector 100 may perform the process of subroutine Sub_A in a parallel process. In this case, the projector launches a new process thread, and when the process of subroutine Sub_A ends, the projector 100 discontinues the process thread.

Next, at step S907, the projector 100, using the capture unit 13 (see FIG. 5), captures an image of the projection region Rgn-P including the projection target (capture step). Moreover, the capture unit 13 outputs the captured image Img-C to the calculation unit 14 (see FIG. 5).

The process of the projector 100 proceeds to step S908.

The projector 100, at step S908, using the calculation unit 14, extracts a feature point (calculation step). The calculation unit 14 extracts a feature point corresponding to the feature point in the captured image Img-C, which was captured previously. Such feature point will be denoted as “corresponding point” in the following.

The process of the projector 100 proceeds to step S909.

The projector 100, at step S909, using the calculation unit 14, calculates the quantity of movement (calculation step). The calculation unit, using the corresponding point extracted at step S908, calculates the quantity of change in a relative positional relationship between the projector 100 and the projection target.

The process of the projector 100 proceeds to step S910.

The projector 100, at step S910, using the storage unit 17, updates the relative positional relationship information for reference. In the storage unit 17, the captured image Img-C and the feature point are updated with the captured image Img-C captured at step S907 and the feature point (corresponding point) extracted at step S908, respectively.

The process of the projector 100 proceeds to step S911.

The projector 100, at step S911, using the calculation unit 14, calculates the motion parameter (calculation step). Moreover, the projector 100 stores (updates) the motion parameter calculated by the calculation unit 14 into the storage unit 17. The calculation unit 14 can calculate the motion parameter, by using the quantity of change calculated at step S909.

The process of the projector 100 proceeds to step S912.

The projector 100, at step S912, using the calculation unit 14, updates the correction parameter (calculation step). The calculation unit 14 updates the distortion parameter by using the motion parameter calculated at step S912.

The process of the projector 100 proceeds to step S913.

The projector 100, at step S913, using the control unit 10, determines whether to finish the operation for projecting the image. The control unit 10 may determine whether to finish the operation for projecting the image based on the information input by the input/output unit 16.

In the case of determining to finish the operation for projecting the image (step S913 YES), the process of the projector 100 proceeds to END in FIG. 9, and the operation for projecting the image ends. Otherwise, the process of the projector 100 returns to step S901.

[Example of Operation for Extracting Feature Point]

With reference to FIGS. 11 to 13, the operation for extracting a feature point by the projector 100 according to the first embodiment of the present invention will be described.

FIG. 11 is an explanatory diagram illustrating an example of the operation for extracting a feature point by the projector 100 according to the present embodiment. The upper half of FIG. 11 shows the feature points before the relative positional relationship changes. The lower half of FIG. 11 shows the feature points after the relative positional relationship changes. FIG. 12 is an explanatory diagram illustrating an example of the operation for projecting a pattern by the projector 100. FIG. 13 is an explanatory diagram illustrating an example of the captured image Img-C when the projector 100 projects the pattern.

As shown in the upper half of FIG. 11, the projector 100 according to the present embodiment extracts previously the feature points in the captured reference image Img-Cr. In the upper half of FIG. 11, the projector 100 captures also an image of bodies outside the screen Scr (projection target). The projector 100 captures an image of a region including, for example, a pattern of a wall, a switch mounted on the wall, a wall clock, an award certificate a painting displayed on the wall, or the like.

The projector 100 may extract feature points within a region corresponding to the screen Scr (projection target). Moreover, the projector 100 may extract feature points outside the region corresponding to the Screen Scr (projection target). Furthermore, the projector 100 may extract feature points in a region other than the matching excluding an outside target region Rgn-To, selected by the user.

As shown in the lower half of FIG. 11, the projector 100 according to the present embodiment extracts the feature points after the relative positional relationship changes. That is, the projector 100 extracts the feature points in the captured detection image Img-Cd. Next, the projector 100 performs matching (pairing) for the feature points extracted in the upper half of FIG. 11 and the feature points extracted in the lower half of FIG. 11. The projector 100 performs the matching for the pairs of feature points f1 to f6, as shown in FIG. 11.

Since the wall clock (f4 and f5) in FIG. 11 is in the region other than the matching excluding the outside target region Rgn-To, the wall clock may be excluded from the target of the matching. Moreover, the left end of the award certificate is outside the captured detection image Img-Cd, and the award certificate may be excluded from the target of the matching.

Since the calculation unit 14 calculates the matrix Pₘ by using the three corresponding points (matching for feature points), the projector 100 may perform the matching only for three feature points. Moreover, the projector 100 performs preferably the matching for feature points, which are outside the projected frame, more preferably the matching for feature points, which are at a wide range beyond the possible projection region. According to the above operation, the accuracy in the motion correction (for example, being jiggled) can be enhanced.

Furthermore, the projector 100 may determine the content of implementation of the matching for feature points, corresponding to a time of projection (or, a time of capture of an image), a content of the motion correction, or the like. Moreover, the projector 100, when the corresponding point is determined, may find the corresponding relationship by using a method such as SIFT (Scale-Invariant Feature Transform) or SURF (Speeded Up Robust Features) may be employed instead of referring to peak positions of pixel values.

According to the above, the operation for extracting the feature points by the projector 100 according to the present embodiment ends. That is, the operation for extracting the feature points required for calculating the motion parameter by the calculation unit 14 ends.

On the other hand, as shown in FIGS. 12 and 13, the projector 100 according to the present embodiment may irradiate pattern light and extract feature points. FIGS. 12 and 13 illustrate an example where the pattern light has a pattern of circles. The shape of the pattern light used in the present embodiment is not limited to circles. That is, as long as the element of the pattern in the pattern light has a shape, a thickness, a color, or the like, by which a feature point can be extracted, any pattern light may be used.

As shown in FIG. 12, the projector 100 irradiates the circular pattern light onto the projection region Rgn-P including the Screen Scr (projection target). Moreover, the projector 100 captures an image of the capture region Rgn-C (Img-Cr in FIG. 13), on which the circular pattern light is irradiated. Accordingly, the projector 100 selects one of the circles in the pattern light, and extracts a feature point (corresponding point).

The projector 100 according to the first embodiment of the present invention, as described above, can correct an influence from jiggling (shaking) of a projection image occurring in the case of projecting from the projector 100, which is held in hand, by an image processing. Moreover, since the projector 100 according to the present embodiment can handle the projection including the case where the projection target moves, the projector 100 can project a projection image onto a moving body. Furthermore, the projector 100 according to the present embodiment not only moves (shifts) the projected image, but also corrects the distortion simultaneously.

Moreover, the projector 100 according to the first embodiment of the present invention, can extract the projection target (i.e. an image which moves in the same way as the projection target) from the captured image captured by the capture unit (camera). Moreover, since the projector 100 according to the present embodiment extracts the projection target (image which moves in the same way as the projection target), the projector 100 can adjust (fit) a position of the projection image to the position of the moving projection target. Furthermore, the projector 100 according to the present embodiment can update the motion parameter which represents a motion of the capture unit (camera), and update the distortion parameter by using the motion parameter. The projector 100 may update the correction parameter (distortion parameter and/or motion parameter) at a time interval in a range from 1/60 seconds to 1/30 seconds.

### Second Embodiment

### Configuration and Function of Projector

FIGS. 5 to 8 illustrate an example of a configuration and a function of a projector according to the second embodiment of the present invention. The configuration and the function of the projector according to the present embodiment are essentially the same as the configuration and the function of the projector 100 according to the first embodiment, and an explanation is omitted.

[Operation for Projecting Image]

By using FIG. 14, the operation for projecting an image (projection image, rectified image) by the projector according to the present embodiment will be described. FIG. 14 is a flowchart illustrating an example of the operation (projection operation) of the projector according to the present embodiment.

The projector according to the present embodiment is different from the projector according to the first embodiment in that timing for updating information on a deformation of the projection surface is determined (step S1407 in FIG. 14). The operation will be described specifically with reference to FIG. 14.

As shown in FIG. 14, the projector according to the present embodiment, at steps S1401 to S1406, performs the same processes as those at steps S901 to S906 in FIG. 9 by the projector 100 according to the first embodiment. The process of the projector proceeds to step S1407.

The projector according to the present embodiment may perform the process of subroutine Sub_B (steps S1408 to S1413) and the process of subroutine Sub_C (steps S1414 to S1417) in a parallel process. In this case, the projector launches new process threads, and when the process of subroutine Sub_B or subroutine Sub_C ends, the projector discontinues the process thread.

Next, at step S1407, the projector according to the present embodiment, determines the timing for updating the information on the deformation of the projection surface. That is, the projector selects whether the motion parameter is updated in subroutine Sub_B or the distortion parameter is updated in Subroutine Sub_C. In the case that the information on the deformation of the projection surface is updated at a predetermined time interval, the projector can determine the timing for updating the information on the deformation of the projection surface according to whether the predetermined time has elapsed. Moreover, the projector may select whether to update the motion parameter or to update the distortion parameter based on three-dimensional data calculated by the calculation unit 14 using the captured image Img-C (capture unit 13) as the information on the deformation of the projection surface. The projector may update the distortion parameter, in the case that the projection target is, for example a screen, and when the screen moves by, for example, wind.

When the projector determines that it is not the timing for updating the information on the deformation of the projection surface (step S1407 NO, i.e., it is the timing for updating the motion parameter), the process of the projector proceeds to step S1408. Otherwise, the process of the projector proceeds to step S1414.

At steps S1408 to S1413, the projector performs the same processes as those at steps S907 to S912 in FIG. 9 of the projector 100 according to the first embodiment. That is, the projector updates the motion parameter (correction parameter). The process of the projector proceeds to step S1418.

On the other hand, at steps S1414 to S1417, the projector performs the same processes as those at steps S1002 to S1005 in FIG. 10 of the projector 100 according to the first embodiment. That is, the projector updates the distortion parameter (correction parameter). The process of the projector proceeds to step S1418.

The projector, at step S1418, using the control unit 10, determines whether to finish the operation for projecting the image. The control unit 10 may determine whether to finish the operation for projecting the image based on the information input by the input/output unit 16.

In the case of determining to finish the operation for projecting the image, the process of the projector proceeds to END in FIG. 14, and the operation for projecting the image ends. Otherwise, the process of the projector returns to step S1401.

The projector according to the second embodiment of the present invention, as described above, achieves the same effect as the projector 100 according to the first embodiment.

[Program and Recording Medium Storing Program]

The program according to the present invention, causes a process in a method of controlling a projector, which captures an image of a projection target, a projection image being projected onto the projection target, and corrects the projection image by using the captured image, the process includes a step of projecting the projection image onto the projection target; a step of capturing an image of a projected region including the projection target, by using a capture unit; a step of calculating three-dimensional data regarding the projected region, and calculating a correction parameter using the calculated three-dimensional data; and a step of correcting the projection image using the calculated correction parameter, wherein the correction parameter includes a distortion parameter and a motion parameter, the distortion parameter is used in performing a first correction corresponding to a shape of the projection target, and the motion parameter is used in performing a second correction corresponding to at least one of a movement of the projection unit and a movement of the projection target, and the rectified projection image is projected. Moreover, the step of calculating calculates, when a relative positional relationship between the projection target and the capture unit changes, the motion parameter using one captured image, which is captured before the relative positional relationship changes, and using an other captured image, which is captured after the relative positional relationship changes, and updates the distortion parameter using the calculated motion parameter, and the step of correcting performs the first correction using the updated distortion parameter. According to the above, the same effect as the projectors 100 and 110 according to the present embodiments is obtained.

Moreover, the present invention may be a recording medium storing the above program and readable be a computer. The recording medium storing the above program may be a FD (flexible disk), a CD-ROM (Compact Disk-ROM), a CD-R (CD recordable), a DVD (Digital Versatile Disk), an other computer readable media. Furthermore, a flash memory, a semiconductor memory, such as a RAM (random access memory), a ROM (read-only memory), a memory card, a HDD (Hard Disk Drive), and other computer readable device may be used.

The recording medium storing the above program, includes temporarily storing in a volatile memory inside a computer system, which is a server or a client in the case that the program is transmitted via a network. The network includes a LAN (Local Area Network), a WAN (Wide Area Network) such as the Internet, a communication line such as a telephone line, or the like. The volatile memory is, for example, a DRAM (Dynamic Random Access Memory). Furthermore, the above program, stored in the recording medium, may be a differential file, which realizes its function if it is combined with a program already stored in the computer system.

### EXAMPLE

The present invention will be explained by using a projector according to the Example.

### First Example

The present invention will be described using the projector 110 according to the first Example of the present invention.

[External View of Projector]

FIGS. 15A and 15B illustrates external views of the projector 110 according to the first Example. FIGS. 15A and 15B are a schematic external view of a front surface and a schematic external view of a rear surface, respectively, illustrating an example of the projector 110.

As shown in FIGS. 15A and 15B, in the projector 110 according to the present Example, the projection unit 100P (projection unit 12 in FIG. 5) and the capture unit 100C (capture unit 13 in FIG. 5) are not integrated with each other. Moreover, when projecting and capturing, the projection unit 100P is used in the state that the capture unit 100C is attached to the projection unit 100P. That is, the projector 110 according to the present Example, includes the projection unit 100P, and uses the detachable capture unit 100C.

The projector, which can be used for the present invention, may be a projector system, in which plural devices, each of which is equipped with the function, shown in FIG. 6, are wired and/or wirelessly connected with each other. The projector system may be, for example, a system including a projection device equipped with the function of the projection unit 100p (projection unit 12 in FIG. 5) and a capture device equipped with the function of the capture unit 100C (capture unit 13 in FIG. 5). Furthermore, the projector system may be a system utilizing a system which can communicate with each other by a communication unit wired and/or wirelessly (for example, a cloud computing system).

[Configuration and Function of Projector, and Operation for Projecting Image]

The configuration and function of the projector 110 according to the present Example and the operation for projecting the image are the same as the projector 100 according to the first embodiment. An explanation is therefore omitted.

The projector 110 according to the first Example, as described above, achieves the same effect as the projector 100 according to the first embodiment.

Moreover, the projector 110 according to the first Example uses an external device, such as a capture device or an image processing device. Accordingly, the amount of processing in the projector can be reduced, the size and weight are reduced, and the structure is simplified.

Furthermore, the projector 110 according to the first Example can utilize a capture unit of a PC (Personal Computer). For example, in the case of giving a presentation by using the projector 110, the function of the PC, used in the presentation, can be utilized by the projector 110.

### Second Example

The present invention will be described using the projector according to the second Example of the present invention.

[Configuration and Function of Projector, and Operation for Projecting Image]

The configuration and function of the projector according to the present Example and the operation for projecting the image are the same as the projector 100 according to the first embodiment. An explanation is therefore omitted.

[Operation for Projecting Image]

FIG. 16 illustrates an operation for projecting an image by the projector according to the present Example. FIG. 16 is an explanatory diagram illustrating an example of jiggling of the projector according to a second example.

As shown in FIG. 16, the projector according to the present Example is held by a user Psn, and projects a projection image Img-P onto an arbitrary surface. The projector may move (wobble) the projection image Img-P, which is projected, by the user Psn's jiggling.

During projecting an image, the user Psn depresses a selection button 100Bc (see FIG. 1) and a setting button 100Bb (see FIG. 1) of the projector according to the present Example, and a projection target region Rgn-T (see FIG. 2) is set. Next, the projector, in order to project a projection image Img-P within the projection target region Rgn-T, using the calculation unit 14, calculates the correction parameter (distortion parameter), which deforms the projection image Img-P (enlargement, contraction, or trapezoidal correction). Next, the projector, using the calculated correction parameter, corrects (deforms) the projection image Img-P. Moreover, the projector projects the rectified projection image Img-P. That is, the projector projects the projection image Img-P in the projection target region Rgn-T.

Moreover, the projector according to the present Example, when jiggling occurs during the projection, in order to project the projection image Img-P in the projection target region Rgn-T, using the calculation unit 14, calculates the correction parameter (motion parameter), which moves (rotates or translates) the projection image Img-P. Next, the projector, using the calculated correction parameter, corrects (moves) the projection image Img-P. Moreover, the projector projects the rectified projection image Img-P. That is, even when the jiggling occurs, the projector can continue the projection of the image, such as a video, at a certain position (projection target region Rgn-T), by the image processing, which cancels the jiggling. Moreover, even when the projection target position (an external surface of the projection target region Rgn-T) is distorted, the projector corrects the projection image Img-P in real time, by using the correction parameter (distortion parameter and the motion parameter), and can continue the projection in a state without distortion.

The projector according to the second Example, as described above, achieves the same effect as the projector 100 according to the first embodiment.

### Third Example

The present invention will be described using the projector according to the third Example of the present invention.

[Configuration and Function of Projector, and Operation for Projecting Image]

The configuration and function of the projector according to the present Example and the operation for projecting the image are the same as the projector 100 according to the first embodiment. An explanation is omitted.

[Operation for Projecting Image]

FIGS. 17A to 17D illustrate operations for projecting images by the projector according to the present Example. FIGS. 17A to 17D are explanatory diagrams illustrating projection operations (operation of projection onto the projection target) of the projector according to the present Example;

As shown in FIGS. 17A to 17D, the projector according to the present Example, even when a moving target (projection target) TG moves, can continue the projection tracking the movement of the moving target. The moving target is, for example, a car, a bus, an airplane, or the like.

Specifically, a user inputs a timing of projection to the projector according to the present Example. The projector during the projection, as shown in FIG. 17A, halts the projection for a short period, and captures a captured image Img-C of the projection target (moving target) TG. The short period is, for example, one hundredth of a second. Accordingly, the projector can capture (obtain) the captured image Img-C (shape) of the projection target (moving target) TG by an operation, which is almost undetected by a human eye, i.e. the operation for halting the projection in the short period.

Moreover, the projector according to the present Example, using the calculation unit 14 (see FIG. 5), based on the result of the capture, extracts the feature points in the projection target (moving targets) TG. Furthermore, the projector sets a projection target region Rgn-T in a region corresponding to the projection target (moving target) TG.

Next, the projector according to the present Example, as shown in FIG. 17B, projects a projection image Img-P onto the projection target (moving target) TG. Next, the projector, as shown in FIG. 17C, captures a captured image Img-C of the projection target (moving target) TG at predetermined time intervals as above, and calculate a quantity of movement (quantity of transfer) of the projection target (moving target) TG by matching the feature points. Moreover, the projector, using the calculation unit 14, calculates a motion parameter (correction parameter) based on the calculated quantity of movement.

Furthermore, the projector according to the present Example, using the calculated correction parameter, corrects the projection image in real time. Then, the projector, as shown in FIG. 17D, using the projection unit 12, projects the rectified projection image onto the projection target region Rgn-T.

The projector according to the present Example, as explained above, achieves the same effect as the projector 100 according to the first embodiment.

The projector according to the present Example, as explained above, can track not only the movement of the projector, but also a motion of the projection target, and the projection onto a moving target (moving body) is possible. Furthermore, even when a background itself changes in the captured image or even when the positional relationship between the projection target and the capture unit changes, the projector according to the present Example can recognize only the projection target and track it. Accordingly, the projector according to the present Example, can project an image also onto a moving body, without changing the relative position. Moreover, the projector according to the present Example, when the projection target region Rgn-T leaves from the capture region Rgn-C, can suspend the projection of the projection image.

### Fourth Example

The present invention will be described using the projector according to the fourth Example of the present invention.

[Configuration and Function of Projector, and Operation for Projecting Image]

The configuration and function of the projector according to the present Example and the operation for projecting the image are the same as the projector 100 according to the first embodiment. An explanation is omitted.

[Operation for Updating Correction Parameter]

With reference to FIGS. 18 and 19, the operation for updating the correction parameter by the projector according to the present Example will be described. FIG. 18 is an explanatory diagram illustrating an example of the operation of a projector. FIG. 19 is a flowchart illustrating an example of a projection operation of the projector.

As shown in FIG. 19, the projector according to the present Example, at step S1901, projects the projection image Img-P from the projection unit 100P (see FIG. 1) by a user onto the projection region Rgn-P (see FIG. 2) including the projection target. The user depresses the start button (calibration button) 100Ba, and the projector acquires a captured image Img-C by the capture unit 100C (see FIG. 1). Moreover, the user depresses the selection button 100Bc (see FIG. 1) and the setting button 100Bb (see FIG. 1), and the projector selects projection target region Rgn-T (see FIG. 2).

The process of the projector proceeds to step S1902.

The projector according to the present Example, at step S1902, using the control unit 10 (see FIG. 5), detects a timing for projecting red light by the projection unit 12.

Specifically, in the case of a projector of the DLP (Digital Light Processing) type according to the present Example, which projects a projection image, as shown in FIG. 18, projects each of red, green and blue lights by time division by rotating the color wheel CW. The control unit 10 (projector) detects the timing for projecting the red light.

The process of the projector proceeds to step S1903.

The projector according to the present Example, at step S1903, projects the red light using the projection unit 12. The projector, at step S1904, using the capture unit 13, captures the capture region Rgn-C (see FIG. 2), on which the red light is projected, and acquires the captured image Img-C. Then, the process of the projector proceeds to step S1905.

The projector according to the present Example, at step S1905, using the calculation unit 14, extracts a red color component from the captured image Img-C. Then, the process of the projector proceeds to step S1906.

The projector according to the present Example, at step S1906, using the calculation unit 14, based on the extracted red color component, calculates a correction parameter (distortion parameter). Moreover, the projector, using the calculated correction parameter, updates the correction parameter. Then, the process of the projector proceeds to END in FIG. 19, and the operation for updating the correction parameter ends.

The projector according to the fourth Example, as explained above, achieves the same effect as the projector 100 according to the first embodiment.

The projector according to the fourth Example halts the projection of the projection image (such as a content) for a short period, but a pattern light is projected instead of the projection image during the projection of red light. In the projector according to the present Example, the interruption time of the projection image is about one hundredth of a second based on the number of rotations of the color wheel CW, and the pattern light can be projected without providing the user a feeling of disorientation. Moreover, the projector according to the present Example, projects a blue color component and a green color component of the same projection image (frame contents), and a projection image (content information) at the moment can be viewed to some extent, though the color shade changes. Accordingly, the projector according to the present Example can reduce the amount of interruption.

Furthermore, the projector according to the fourth Example, since the colors of the projected patterns are already known, can enhance the accuracy of extracting a pattern. That is, the projector according to the present Example, by extracting only a red color component from a captured picture, even when noise other than the pattern is superimposed, can easily eliminate the noise, which includes a high saturation of blue and green color components.

Further, the present invention is not limited to these embodiments, but various variations and modifications may be made without departing from the scope of the present invention.

The present application is based on and claims the benefit of priority of Japanese Priority Application No. 2013-050894 filed on Mar. 13, 2013, with the Japanese Patent Office, the entire contents of which are hereby incorporated by reference.

What is claimed is:

1. A projector, which captures an image of a projection target, a projection image being projected onto the projection target, and corrects the projection image by using the captured image, the projector comprising:
a projection unit that projects the projection image onto the projection target;
a capture unit that captures an image of a projected region including the projection target;
a calculation unit that calculates three-dimensional data regarding the projected region, and calculates a correction parameter using the calculated three-dimensional data; and
a correction unit that corrects the projection image using the correction parameter calculated by the calculation unit, wherein
the calculation unit calculates a distortion parameter and a motion parameter, as the correction parameter, based on the captured image, and
the correction unit performs a first correction corresponding to a shape of the projection target using the distortion parameter, and performs a second correction corresponding to at least one of a movement of the projection unit and a movement of the projection target.

2. The projector, as claimed in claim 1, wherein
the capture unit captures a plurality of images of the projected region with timings of capture different from each other, and
the calculation unit calculates the distortion parameter using one captured image of the plurality of captured images, and calculates the motion parameter using two captured images of the plurality of captured images.

3. The projector, as claimed in claim 1, wherein
the calculation unit calculates the motion parameter, when a relative positional relationship between the projection target and the capture unit changes, using one captured image, which is captured before the relative positional relationship changes, and using an other captured image, which is captured after the relative positional relationship changes,
the calculation unit updates the distortion parameter using the calculated motion parameter,
the correction unit performs the first correction using the updated distortion parameter, and
the projection unit projects the corrected projection image.

4. The projector, as claimed in claim 1, wherein
the calculation unit extracts a feature point included in the captured image, and calculates the motion parameter using the extracted feature point.

5. The projector, as claimed in claim 4, wherein
the correction unit specifies, when the projection target moves, a predetermined position of the moving projection target using the feature point extracted by the calculation unit, and
the correction unit corrects the projection image using the correction parameter so that the projection image is projected at the predetermined position.

6. The projector, as claimed in claim 4, wherein
the projection unit projects a red light, a blue light and a green light, which are filtered from the projection image,
the capture unit captures an image of one of the red light, the blue light and the green light when the calculation unit extracts the feature point, and
the calculation unit extracts the feature point based on the captured image captured by the capture unit.

7. A method of controlling a projector, which captures an image of a projection target, a projection image being projected on the projection target, and corrects the projection image by using the captured image, the method comprising:
projecting the projection image onto the projection target;
capturing an image of a projected region including the projection target, by using a capture unit;
calculating three-dimensional data regarding the projected region, and calculating a correction parameter using the calculated three-dimensional data; and
correcting the projection image using the calculated correction parameter, wherein
the correction parameter includes a distortion parameter and a motion parameter,
the distortion parameter is used in performing a first correction corresponding to a shape of the projection target, and the motion parameter is used in performing a second correction corresponding to at least one of a movement of the projection unit and a movement of the projection target, and
the corrected projection image is projected.

8. The method of controlling the projector, as claimed in claim 7, wherein
when a relative positional relationship between the projection target and the capture unit changes,
the motion parameter is calculated using one captured image, which is captured before the relative positional relationship changes, and using an other captured image, which is captured after the relative positional relationship changes,
the distortion parameter is updated using the calculated motion parameter, and
the first correction is performed using the updated distortion parameter.

9. A non-transitory computer-readable storage medium storing a program for causing a projector to perform a process of capturing an image of a projection target, a projection image being projected onto the projection target, and correcting the projection image by using the captured image, the process comprising:
a step of projecting the projection image onto the projection target;
a step of capturing an image of a projected region including the projection target, by using a capture unit;
a step of calculating three-dimensional data regarding the projected region, and calculating a correction parameter using the calculated three-dimensional data; and
a step of correcting the projection image using the calculated correction parameter, wherein
the correction parameter includes a distortion parameter and a motion parameter,
the distortion parameter is used in performing a first correction corresponding to a shape of the projection target, and the motion parameter is used in performing a second correction corresponding to at least one of a movement of the projection unit and a movement of the projection target, and
the corrected projection image is projected.
